(19) United States
(12) Patent Application Publication
(10) Pub. No.: US 2010/0079453 A1
(43) Pub. Date: Apr. 1, 2010

(54) 3D Depth Generation by Vanishing Line Detection

(76) Inventors: Liang-Gee Chen, Taipei (TW); Chao-Chung Cheng, Taipei (TW); Yi-Min Tsai, Taipei (TW); Ling-Hsiu Huang, Tainan (TW)

Correspondence Address: STOUT, UXA, BUYAN & MULLINS LLP, 4 VENTURE, SUITE 300, IRVINE, CA, 92618, US

(21) Appl. No.: 12/242,567

(22) Filed: Sep. 30, 2008

(51) Int. Cl. G06T 15/20

(52) U.S. Cl. 345/421

(57) ABSTRACT

A system and method of generating three-dimensional (3D) depth information is disclosed. The vanishing point of a two-dimensional (2D) input image is detected based on vanishing lines. The 2D image is classified and segmented into structures based on detected edges. The classified structures are then respectively assigned depth information.

### BACKGROUND OF THE INVENTION

1. Field of the Invention

The present invention generally relates to three-dimensional (3D) depth generation, and more particularly to 3D depth generation by vanishing line detection.

2. Description of the Prior Art

When three-dimensional (3D) objects are mapped onto a two-dimensional (2D) image plane by prospective projection, such as an image taken by a still camera or video captured by a video camera, a lot of information, such as the 3D depth information, disappears because of this non-unique many-to-one transformation. That is, an image point cannot uniquely determine its depth. Recapture or generation of the 3D depth information is thus a challenging task that is crucial in recovering a full, or at least an approximate, 3D representation, which may be used in image enhancement, image restoration or image synthesis, and ultimately in image display.

One of the conventional 3D depth information generation methods is performed by detecting vanishing lines and a vanishing point in a perspective image to which parallel lines appear to converge. Depth information is then generated encircling the vanishing point by assigning larger depth value as the points are approaching the vanishing point. In other words, the generated 3D depth information has a gradient, or greatest rate of magnitude change, pointing in the direction toward the vanishing point. This method disadvantageously gives little consideration to the difference among prior knowledge of different areas. Accordingly, the points located at the same distance away from the vanishing point but within different areas are monotonously assigned the same magnitude.

Another one of the conventional 3D depth information generation methods is performed by classifying the different areas according to the pixel value and chroma/color. Depth information is then assigned along the gradient, or the greatest rate of magnitude change of the pixel value and/or color. For example, larger depth value is assigned to a deeper area with larger pixel value and/or color. This method disadvantageously neglects the importance of border (or boundary) perception present in the human visual system. Accordingly, the points located at different depth distance but with the same pixel value and/or color may be mistakenly assigned the same depth information.

For reasons including the fact that conventional methods could not faithfully or correctly generate 3D depth information, a need has arisen to propose a system and method of 3D depth generation that can recapture or generate 3D depth information to faithfully and correctly recover or approximate a full 3D representation.

### SUMMARY OF THE INVENTION

In view of the foregoing, it is an object of the present invention to provide a novel system and method of 3D depth information generation for faithfully and correctly recovering or approximating a full 3D representation.

According to one embodiment, the present invention provides a system and method of generating three-dimensional (3D) depth information. The vanishing point of a two-dimensional (2D) input image is detected based on vanishing lines. The 2D image is classified and segmented into structures based on detected edges. The classified structures are then respectively assigned depth information that faithfully and correctly recovers or approximates a full 3D representation.

### BRIEF DESCRIPTION OF THE DRAWINGS

FIG. 1 illustrates a block diagram of a 3D depth information generation system, including a line detection unit, according to one embodiment of the present invention;

FIG. 2 illustrates an associated flow diagram demonstrating the steps of a depth-based image/video enhancement method according to the embodiment of the present invention;

FIG. 3 illustrates a detailed block diagram of the line detection unit of FIG. 1; and

FIGS. 4A to 4E provide exemplary schematics illustrating determinations of the vanishing point by having the detected vanishing lines converging on the vanishing point.

### DETAILED DESCRIPTION OF THE INVENTION

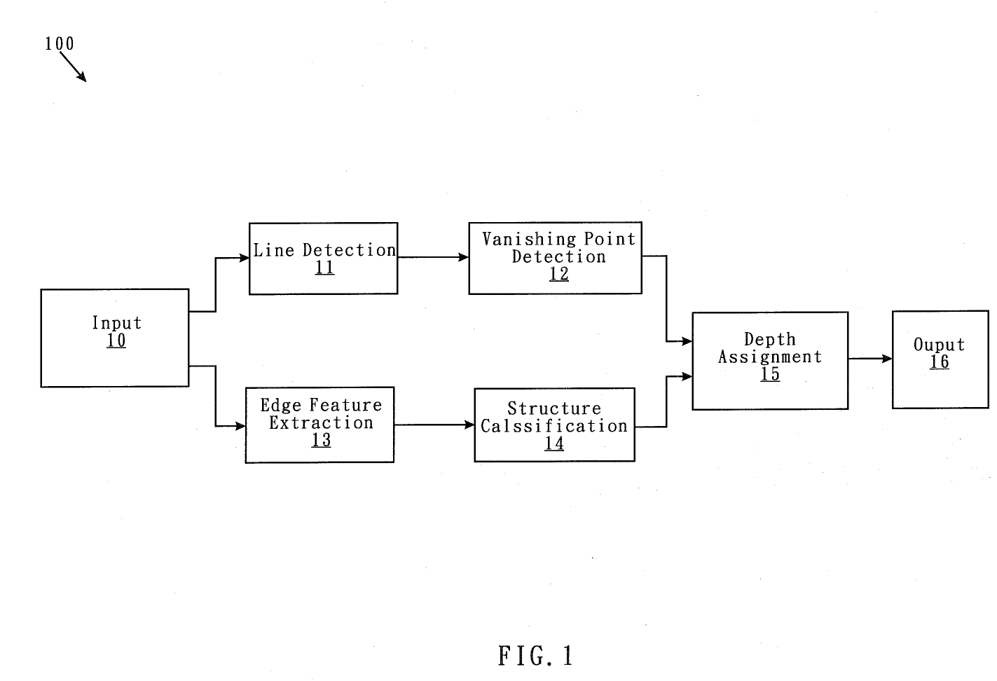

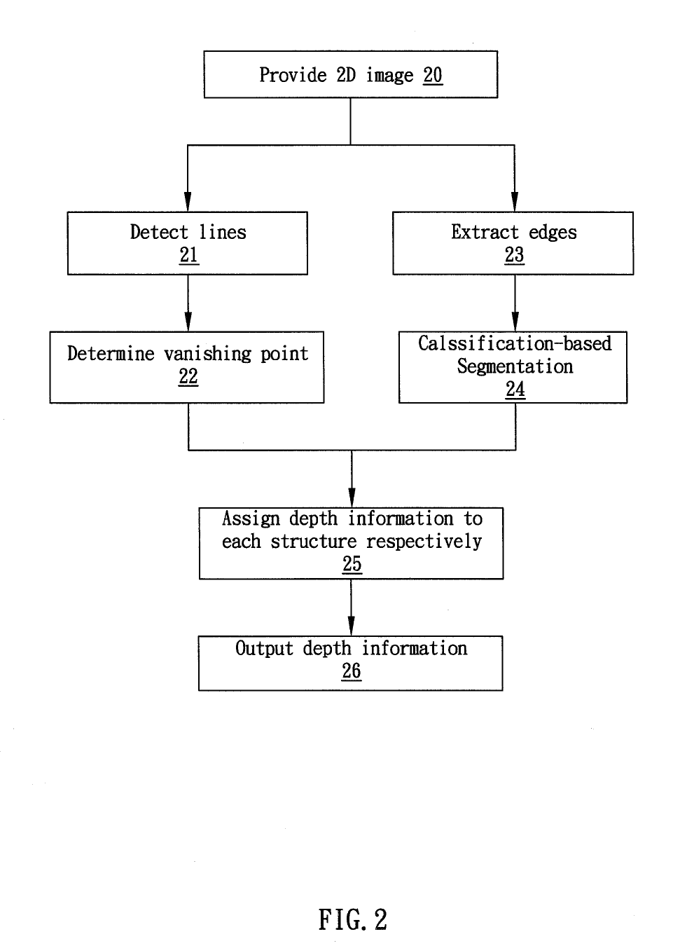

FIG. 1 illustrates a block diagram of a three-dimensional (3D) depth information generation device or system 100 according to one embodiment of the present invention. Exemplary images, including an original image, images during the processing, and a resultant image, are also shown for better comprehension of the embodiment. FIG. 2 illustrates an associated flow diagram demonstrating steps of the 3D depth information generation method according to the embodiment of the present invention.

With reference to these two figures, an input device 10 provides or receives one or more two-dimensional (2D) input image(s) to be image/video processed in accordance with the embodiment of the present invention (step 20). The input device 10 may in general be an electro-optical device that maps 3D object(s) onto a 2D image plane by prospective projection. In one embodiment, the input device 10 may be a still camera that takes the 2D image, or a video camera that captures a number of image frames. The input device 10, in another embodiment, may be a pre-processing device that performs one or more of digital image processing tasks, such as image enhancement, image restoration, image analysis, image compression and image synthesis. Moreover, the input device 10 may further include a storage device, such as a semiconductor memory or hard disk drive, which stores the processed image from the pre-processing device. As discussed above, a lot of information, particularly the 3D depth information, is lost when the 3D objects are mapped onto the 2D image plane, and therefore, according to an aspect of the invention, the 2D image provided by the input device 10 is subjected to image/video processing through other blocks of the 3D depth information generation system 100, which will be discussed below.

The 2D image is processed by a line detection unit 11 that detects or identifies the lines in the image, particularly the vanishing lines (step 21). In this specification, the term “unit” is used to denote a circuit, software, such as a part of a program, or their combination. The attached image associated with the line detection unit 11 shows the detected (vanishing) lines that are superimposed on the original image. In a preferred embodiment, vanishing line detection is performed using Hough transform, which is a frequency-domain processing technique. Other frequency-domain processing, such as fast Fourier transform (FFT), or spatial-domain processing, may be used instead. The Hough transform is a feature extraction technique that is based on U.S. Pat. No. 3,069,654 entitled “Method and Means for Recognizing Complex Patterns” by Paul Hough, and “Use of the Hough Transformation to Detect Lines and Curves in Pictures” by Richard Duda and Peter Hart, Comm. ACM, Vol. 15, pp. 11-15 (January, 1972), the disclosures of which are hereby incorporated by reference. The Hough transform concerns the identification of lines or curves in the image in the presence of imperfections, such as noise, in the image data. In the embodiment, the Hough transform is utilized to effectively detect or identify the lines in the image, particularly the vanishing lines.

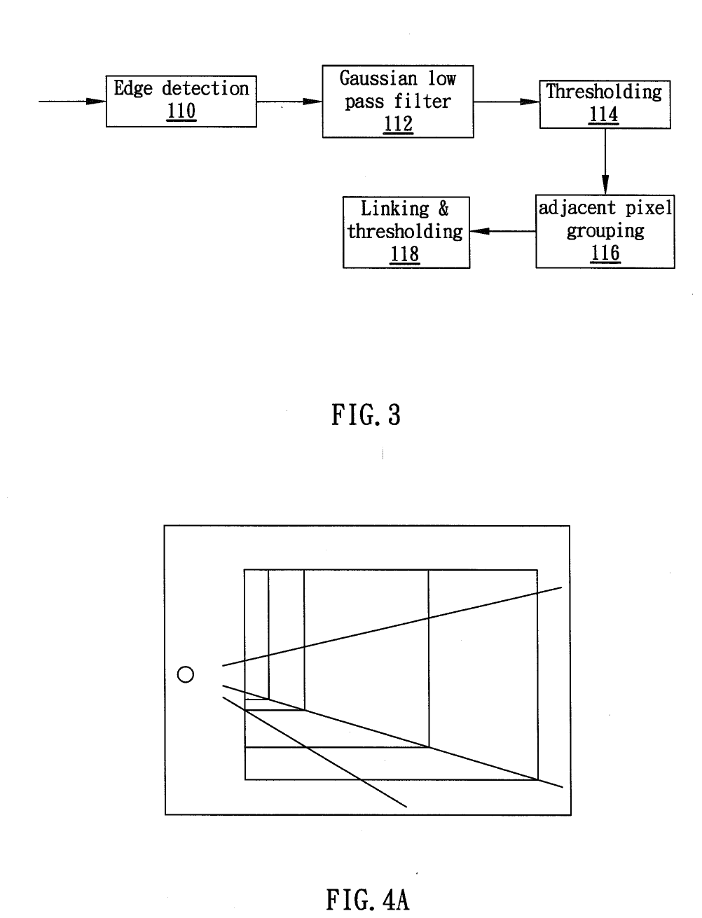

In another embodiment, the vanishing line detection is performed using a method as depicted in FIG. 3. In this embodiment, edge detection 110 is first performed, for example, using Sobel edge detection. Subsequently, a Gaussian low pass filter is used to reduce noise (block 112). In the following block 114, edges greater than a predetermined threshold are kept while others are removed. Further, adjacent but non-connected pixels are grouped (block 116). The end points of the grouped pixels are further linked in block 118, resulting in the required vanishing lines.

Subsequently, a vanishing point detection unit 12 (FIG. 1) determines the vanishing point based on the detected lines obtained in the line detection unit 11 (step 22). Generally speaking, the vanishing point can be considered as the converging point where the detected lines (or their extended lines) cross each other. The image in FIG. 1, which is associated with the vanishing point detection unit 12, shows the determined vanishing point that is superimposed on the original image.

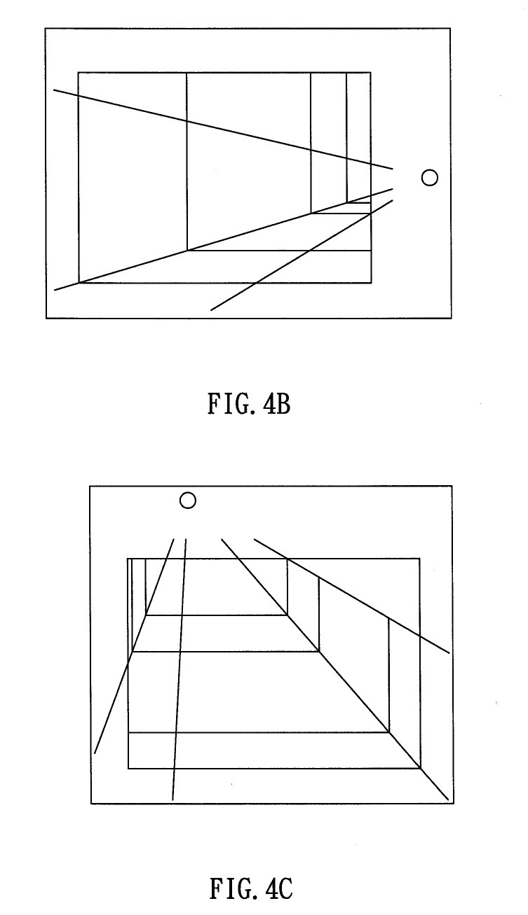

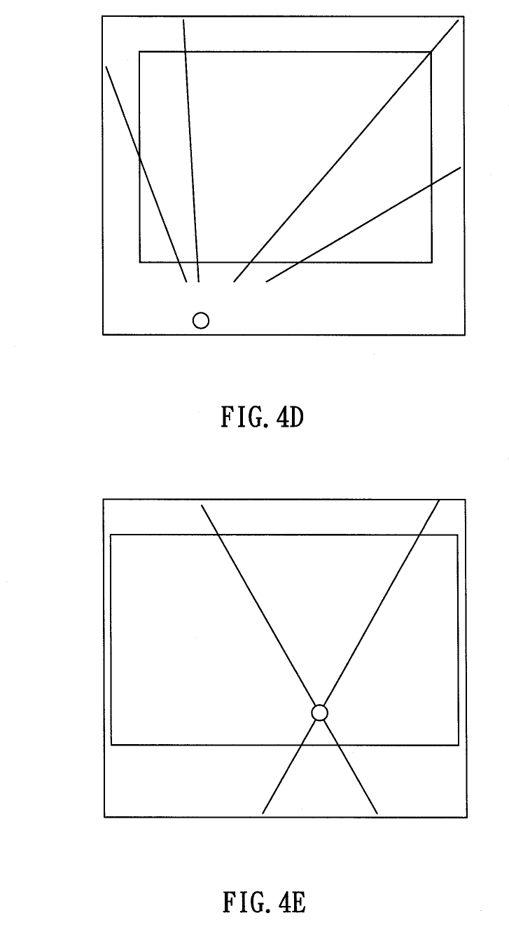

FIGS. 4A to 4E present exemplary schematics illustrating determinations of the vanishing point by having the detected vanishing lines converging on the vanishing point. Specifically, the vanishing lines converge on a vanishing point located to the left in FIG. 4A, to the right in FIG. 4B, to the top in FIG. 4C, to the bottom in FIG. 4D, and inside in FIG. 4E.

With reference to another (lower) path of the 3D depth information generation system 100 of FIG. 1, the 2D image is also processed by an edge feature extraction unit 13 that detects or identifies edges or boundaries among structures or objects (step 23). As the line detection unit 11 and the edge feature extraction unit 13 have some overlapping functions, therefore, they may be, in one embodiment, combined into or may share a single line/edge detection unit.

In a preferred embodiment, edge extraction is performed using a Canny edge filter or a Canny edge detector. The Canny edge filter is an optimal edge feature extraction or detection algorithm developed by John F. Canny in 1986, “A Computational Approach to Edge Detection,” IEEE Trans. Pattern Analysis and Machine Intelligence, 8:679-714, the disclosure of which is hereby incorporated by reference. The Canny edge filter is optimal for edges corrupted by noise. In the embodiment, the Canny edge filter is utilized to effectively extract edge features, as exemplified in FIG. 1 by image associated with the edge feature extraction unit 13.

Subsequently, a structure classification unit 14 segments the entire image into a number of structures based on the information of the edge/boundary features provided by the edge feature extraction unit 13 (step 24). Particularly, the structure classification unit 14 applies the classification-based segmentation technique such that, for example, objects having a relatively small size and/or similar texture are grouped and linked into the same structure. As shown in the exemplary image associated with the structure classification unit 14, the entire image is segmented and classified into four structures or segments, namely, ceiling, ground, right and left vertical sides. The pattern of the classification-based segmentation is not limited to that discussed above. For example, for a scenery image taken in the open air, the entire image may be segmented and classified into the following structures: sky, ground, vertical and horizontal surfaces.

In a preferred embodiment, a clustering technique (such as k-means) is used in performing the segmentation or classification in the structure classification unit 14. Specifically, a few clusters are initially determined, for example, according to the histogram of the image. The distance measure of each pixel is then determined such that similar pixels with small distance measure are grouped into the same cluster, resulting in the segmented or classified structures.

Afterwards, a depth assignment unit 15 assigns depth information to each classified structure respectively (step 25). Generally speaking, each classified structure is assigned the depth information in a distinct manner, although two or more structures may (e.g., additionally or alternatively) be assigned the depth information in the same manner. According to prior knowledge or techniques, the ground structure is assigned the depth values smaller than the ceiling/sky. Specifically, the depth assignment unit 15 assigns the depth information to a structure along its gradient, or greatest rate of magnitude change, pointing in a direction toward the vanishing point, with larger depth value(s) assigned to pixels closer to the vanishing point and vice versa.

An output device 16 receives the 3D depth information from the depth assignment unit 15 and provides a resulting or output image (step 26). The output device 16, in one embodiment, may be a display device for presentation or viewing of the received depth information. The output device 16, in another embodiment, may be a storage device, such as a semiconductor memory or hard disk drive, which stores the received depth information. Moreover, the output device 16 may further, or alternatively, include a post-processing device that performs one or more of digital image processing tasks, such as image enhancement, image restoration, image analysis, image compression or image synthesis.

According to the embodiments of the present invention discussed above, the present invention faithfully and correctly recovers or approximates a full 3D representation compared to conventional 3D depth information generation methods as described in the prior art section in this specification.

Although specific embodiments have been illustrated and described, it will be appreciated by those skilled in the art that various modifications may be made without departing from the scope of the present invention, which is intended to be limited solely by the appended claims.

What is claimed is:

1. A device for generating three-dimensional (3D) depth information, comprising:
means for determining a vanishing point of a two-dimensional (2D) image;
means for classifying a plurality of structures; and
a depth assignment unit that assigns depth information to the classified structures respectively.

2. The device of claim 1, wherein the vanishing-point determining means comprises:
a line detection unit for detecting vanishing lines of the 2D image; and
a vanishing point detection unit for determining the vanishing point based on the detected vanishing lines.

3. The device of claim 2, wherein detected vanishing lines or their extended lines converge on the vanishing point.

4. The device of claim 2, wherein the line detection unit performs the vanishing-lines detection by using Hough transform.

5. The device of claim 2, wherein the line detection unit comprises:
an edge detection unit that detects edges of the 2D image;
a Gaussian low pass filter that reduces noise of the detected edges;
thresholding means for removing the edges that are smaller than a predetermined threshold while retaining the edges that are greater than the predetermined threshold;
means for grouping adjacent but non-connected pixels of the detected edges; and
means for linking end points of the grouped pixels, resulting in the vanishing lines.

6. The device of claim 1, wherein the structures classifying means comprises:
an edge feature extraction unit for detecting edges of the 2D image; and
a structure classifying unit for segmenting the 2D image into the plurality of structures based on the detected edges.

7. The device of claim 6, wherein the edge feature extraction unit performs the edge detection by using a Canny edge filter.

8. The device of claim 1, wherein the structure classifying unit performs the segmentation by using a clustering technique.

9. The device of claim 1, wherein the depth assignment unit assigns a bottom structure with a depth value smaller than a top structure.

10. The device of claim 1, further comprising an input device that maps 3D objects onto a 2D image plane.

11. The device of claim 10, wherein the input device further storing the 2D image.

12. The device of claim 1, further comprising an output device that performs one or more of receiving the 3D depth information and storing or displaying the 3D depth information.

13. A circuit-implemented system for generating three-dimensional (3D) depth information, comprising:
a determiner that is coupled or configured to input first information corresponding to a two-dimensional (2D) image, the determiner being operable to determine a vanishing point of the two 2D image based upon vanishing lines of the 2D image information;
a classifier coupled or configured to input second information corresponding to the 2D image, the classifier being formed with a capability of using the second information to classify one or more structures based upon edges of the 2D image; and
a depth assignment unit operatively coupled to the determiner and the classifier and being configured to assign depth information to the one or more classified structures using the vanishing point.

14. A method of using a device to generate three-dimensional (3D) depth information, comprising:
determining a vanishing point of a two-dimensional (2D) image;
classifying a plurality of structures; and
assigning depth information to the classified structures respectively.

15. The method of claim 14, wherein the vanishing-point determining step comprises:
detecting vanishing lines of the 2D image; and
determining the vanishing point based on the detected vanishing lines.

16. The method of claim 15, wherein detected vanishing lines or their extended lines converge on the vanishing point.

17. The method of claim 15, wherein the vanishing-lines detection step is performed by using Hough transform.

18. The method of claim 15, wherein the vanishing-lines detection step comprises:
detecting edges of the 2D image;
reducing noise of the detected edges;
removing the edges that are smaller than a predetermined threshold while retaining the edges that are greater than the predetermined threshold;
grouping adjacent but non-connected pixels of the detected edges; and
linking end points of the grouped pixels, resulting in the vanishing lines.

19. The method of claim 14, wherein the structures classifying step comprises:
detecting edges of the 2D image; and
segmenting the 2D image into the plurality of structures based on the detected edges.

20. The method of claim 19, wherein the edge detection step is performed using a Canny edge filter.

21. The method of claim 14, wherein the structure classifying step is performed using a clustering technique.

22. The method of claim 14, wherein a bottom structure is assigned a depth value smaller than a top structure in the depth information assignment step.

23. The method of claim 14, further comprising a step of mapping 3D objects onto a 2D image plane.

24. The method of claim 23, further comprising a step of storing the 2D image.

25. The method of claim 24, further comprising a step of receiving the 3D depth information.

26. The method of claim 25, further comprising a step of storing or displaying the 3D depth information.
